(19) United States
(12) Patent Application Publication
(10) Pub. No.: US 2012/0092148 A1
(43) Pub. Date: Apr. 19, 2012

(54) Cellular telephone detection and alarm activator for vehicular safety

(76) Inventor: Jeffrey M. Santos, Plymouth, MA (US)

(21) Appl. No.: 13/275,457

(22) Filed: Oct. 18, 2011

Related U.S. Application Data
(60) Provisional application No. 61/394,579, filed on Oct. 19, 2010.

(51) Int. Cl. B60Q 1/00

(52) U.S. Cl. 340/438

(57) ABSTRACT

Methods and devices are disclosed that generally involve deterring the use of portable electronic devices (“PEDs”) while operating a motor vehicle by triggering one or more visible or audible alerts when such use is detected. These alerts can be sufficiently embarrassing or irritating to the vehicle operator to cause them to stop using the detected PED. In addition, merely knowing that a vehicle is equipped with a system for generating these alerts can be sufficient to deter use of PEDs while operating the vehicle. Deterrence can thus be accomplished without relying on vehicle immobilization or frequency jamming.

### FIELD

The present invention relates to methods and devices for preventing or deterring operation of a motor vehicle while distracted.

### BACKGROUND

It is believed that “distracted driving” contributes to nearly 20 percent of all automobile crashes in the United States and results in thousands of deaths and hundreds of thousands of injuries each year. The use of portable electronic devices (“PEDs”) such as cellular phones is one of the most common forms of distracted driving. Recently, there has been an alarming increase in use of PEDs by drivers that are younger and less experienced behind the wheel.

Many countries and states have proposed legislation that bans the use of PEDs while driving or operating a vehicle, however this type of legislation is often opposed by those who regard it as being too intrusive on drivers. Even where laws have been enacted, they can be difficult to enforce.

Various systems have been proposed that purport to immobilize a vehicle when cell phone use is detected, for example by turning off the vehicle's engine and/or disabling the vehicle's various electrical systems. Systems that involve such unexpected immobilization are very dangerous however. For example, the sudden loss of engine power might leave a vehicle stranded in an intersection or cause a rear-end collision, and the sudden loss of power-assisted steering or braking could cause an operator to lose control of their vehicle. Other systems have been proposed that involve software that executes on the cellular phone itself, however these systems are easily tampered with and are only effective for phones on which the software is installed. A third type of proposed system involves disabling cell phone use by actively “jamming” the frequency or frequencies at which the cell phone communicates, however such systems violate the communications laws of many jurisdictions.

Accordingly, there is a need for improved methods and devices for safely preventing or deterring the use of PEDs while operating a motor vehicle.

### SUMMARY

The methods and devices disclosed herein generally involve deterring the use of PEDs while operating a motor vehicle by triggering one or more visible or audible alerts when such use is detected. These alerts can be sufficiently embarrassing or irritating to the vehicle operator to cause them to stop using the detected PED. In addition, merely knowing that a vehicle is equipped with a system for generating these alerts can be sufficient to deter use of PEDs while operating the vehicle. Deterrence can thus be accomplished without relying on vehicle immobilization or frequency jamming.

In a first aspect, a vehicle safety device is provided that includes a detector configured to detect portable electronic device activity within a vehicle and a control unit configured to trigger an alert when the detector detects portable electronic device activity within the vehicle. The device can also include an override mechanism configured to selectively prevent the alert from being triggered when the detector detects portable electronic device activity within the vehicle. Portable electronic device activity can include transmissions made by a cellular phone while in standby mode. The control unit can activate an alarm system to trigger the alert and the alert can be any of sounding a horn, flashing a light, and playing an audible message.

The override mechanism can include a user interface through which an operator can enter authentication information. Exemplary user interfaces include a touch screen, an application executable on a portable electronic device, and/or a fingerprint reader. Exemplary authentication information includes a password and/or a fingerprint signature of an operator. The override mechanism can optionally include a sensor for detecting a type of a key used to access or start the vehicle.

In one embodiment, the detector includes a direction-finding antenna and is configured to distinguish between a portable electronic device in use by an operator of the vehicle and a portable electronic device in use by a passenger of the vehicle. The control unit can optionally disable a starter of the vehicle if an engine of the vehicle is stopped and the detector detects portable electronic device activity within the vehicle. The control unit can optionally disable shifting of a transmission of the vehicle if the transmission is set to a non-moving gear and the detector detects portable electronic device activity within the vehicle.

In another aspect, a method of deterring use of portable electronic devices within a vehicle is provided that includes detecting portable electronic device activity within the vehicle and triggering an alert if portable electronic device activity is detected. In one embodiment, the alert is only triggered when portable electronic device activity is detected and no override condition exists. Portable electronic device activity can include transmissions made by a cellular phone while in standby mode. The method can also include setting the override condition when an operator enters a valid password, uses a valid key to access or start the vehicle, or enters a valid fingerprint signature. The method can optionally include setting the override condition from an application executed on a portable electronic device.

In one embodiment, triggering the alert can include at least one of activating an alarm system, sounding a horn, and flashing one or more lights. Triggering the alert can also include broadcasting an audible message to a passenger cabin of the vehicle.

The method can optionally include distinguishing between a portable electronic device in use by an operator of the vehicle and a portable electronic device in use by a passenger of the vehicle and only triggering the alert if operator use is detected. The method can also include disabling a starter of the vehicle if an engine of the vehicle is off and portable electronic device activity is detected and/or disabling shifting of a transmission of the vehicle if the transmission is set to a non-moving gear and portable electronic device activity is detected.

### BRIEF DESCRIPTION OF THE DRAWINGS

The invention will be more fully understood from the following detailed description taken in conjunction with the accompanying drawings, in which:

FIG. 1 is a schematic block diagram of one embodiment of a vehicle safety system according to the present invention;

FIG. 2 is a schematic cross-sectional view of a vehicle equipped with another embodiment of a vehicle safety system according to the present invention;

FIG. 3 is a schematic view of the interior of the vehicle of FIG. 2;

FIG. 4 is a schematic block diagram of the vehicle safety system of FIGS. 2-3;

FIG. 5 is a flow chart of one exemplary mode of operation of the vehicle safety system of FIGS. 2-4;

FIG. 6 is a flow chart of another exemplary mode of operation of a vehicle safety system;

FIG. 7 is a perspective view of another exemplary embodiment of a vehicle safety system; and

FIG. 8 is a perspective view of the vehicle safety system of FIG. 7, shown with a housing of the vehicle safety system in an open configuration.

### DETAILED DESCRIPTION

Certain exemplary embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention.

The methods and devices disclosed herein generally involve deterring the use of PEDs while operating a motor vehicle by triggering one or more visible or audible alerts when such use is detected. These alerts can be sufficiently embarrassing or irritating to the vehicle operator to cause them to stop using the detected PED. In addition, merely knowing that a vehicle is equipped with a system for generating these alerts can be sufficient to deter use of PEDs while operating the vehicle. Deterrence can thus be accomplished without relying on vehicle immobilization or frequency jamming.

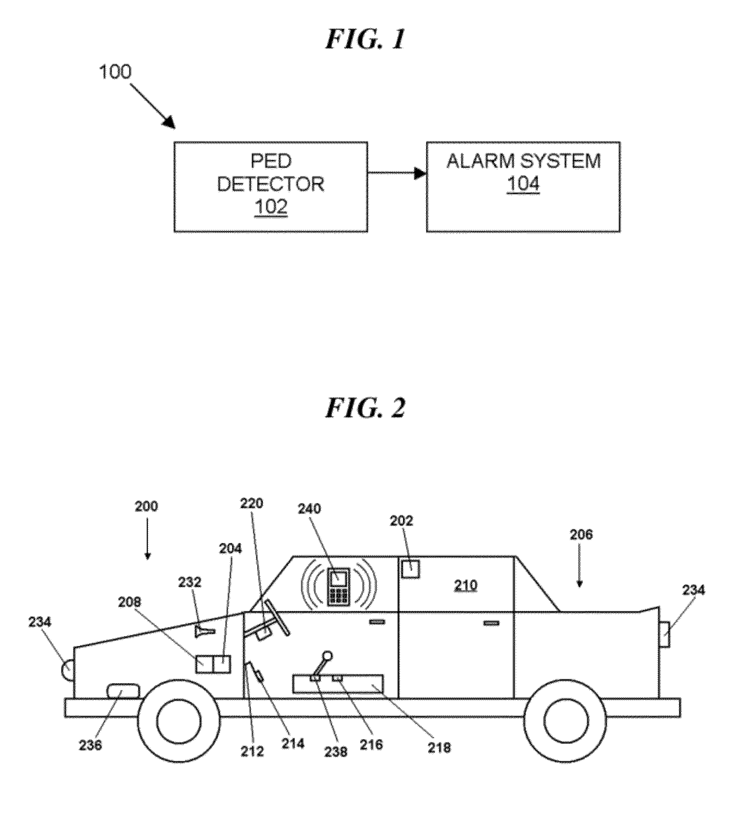

FIG. 1 illustrates a block diagram of one embodiment of a vehicle safety system 100 according to the present invention. The vehicle safety system 100 can be installed in any of a variety of vehicles (e.g., cars, trucks, etc.) as either a stand-alone system or as an add-on to an existing alarm, panic system, or security system in the vehicle. It will be appreciated that the vehicle safety system 100 can be built into new vehicles produced by a vehicle manufacturer, or can be provided as an aftermarket component. In either case, some or all of the system's components can be hardwired into various electrical circuits of the vehicle, and/or can be installed in the vehicle's dashboard, engine compartment, or other location that makes tampering with, disabling, and/or removing the system difficult. The system 100 generally includes a PED detector 102 coupled to an alarm system 104. Power for the system 100 can be provided by the vehicle's existing power bus, and the system 100 can include regulating or conditioning circuitry as is known in the art to derive an appropriate power supply.

When powered on but not in active use, cell phones and other PEDs typically operate in a “standby” mode in which they emit a periodic RF signal to indicate to a service provider that they are powered on and ready to accept incoming calls, messages, or data. These devices also typically emit RF signals when they are in active use (e.g., when they are used to transmit or receive voice, text, or other data). The detector 102 can thus be any of a variety of devices known in the art that are capable of detecting the RF signature of cellular phones or other PEDs. One example of a such a detector is the Wolfhound Cellphone Detector, produced by Berkeley Varitronics Systems of Metuchen, N.J. The detector 102 can optionally distinguish between a cell phone that is in standby mode and a cell phone that is actively being used such that the alarm system 104 is not triggered by cell phones that are in standby mode. Alternatively, the alarm system 104 can be triggered by any cell phone that is powered on and within range of the detector 102, even those that are only in standby mode. This can advantageously encourage operators to completely power-off all PEDs in the vehicle, which can prevent the operator from being distracted by the sounds or vibrations produced when an incoming call, text message, or email is received.

The detector 102 can also include a direction finding (“DF”) antenna such that the detector 102 can discern whether detected cell phone activity is emanating from a device being used by or in the possession of the operator of a vehicle or whether the device is instead being used by a passenger of the vehicle or an individual outside of the vehicle. Accordingly, the system 100 can be configured such that the alarm system 104 is only triggered when cell phone use by an operator is detected.

When PED activity (such as cell phone use) is detected by the detector 102, it provides an indication to the alarm system 104 that a PED has been detected within the vehicle. For example, the detector 102 can apply or remove a voltage to or from an electrical conductor which can be coupled to a trigger input of the alarm system 104. The detector 102 can also be formed integrally with the alarm system 104, or can wirelessly communicate to the alarm system 104 that a PED has been detected.

When triggered by the detector 102, the alarm system 104 can produce an audible alert (e.g., by sounding a loudspeaker or the vehicle's horn) and/or can produce a visible alert (e.g., by flashing one or more of the vehicle's exterior or interior lights). As explained above, these alerts can annoy, irritate, or embarrass the driver enough to cause them to stop using the detected PED.

The system 100 can also include a user interface and/or one or more override mechanisms, as explained below. The user interface can be integrated with a vehicle's dashboard, center stack, navigation system, vehicle computer, stereo system, etc.

FIGS. 2-4 illustrate another embodiment of a system for deterring PED use by vehicle operators. As shown in FIG. 2, the system 200 can be installed in a vehicle 206 and can include a control unit 208, a PED detector 202, and any of a number of other optional components or features. The control unit 208 can include a microprocessor coupled to a memory or other non-transitory computer readable storage medium in which a program is stored for carrying out the various functions of the system 200. Alternatively, the functions of the system 200 and/or the control unit 208 can be entirely hardware-implemented. A first input of the control unit 208 is coupled to the detector 202 as described above. In the illustrated embodiment, the detector 202 is installed within the passenger compartment 210 of the vehicle 206 to optimize detection of a PED 240 disposed within the vehicle 206 and to prevent spurious detections of PEDs external to the vehicle 206.

The system 200 can also include one or more override mechanisms for activating or deactivating alerts. For example, the output of a parking brake sensor 212 can be coupled to an input of the control unit 208 such that the system 200 is disabled when the parking brake 214 of the vehicle 206 is set. Similarly, the control unit 208 can receive the output of a transmission sensor 216 and can disable the system 200 when the transmission 218 of the vehicle 206 is placed in a non-moving gear (e.g., when the transmission is in “park”). The control unit 208 can also be coupled to an ignition/key sensor 220 such that the system 200 is disabled when the ignition is in the “off” or “accessory” positions. In one embodiment, the ignition/key sensor 220 can distinguish between a key belonging to an individual who is not permitted to use PEDs while driving and a key belonging to an individual who is permitted to use PEDs. For example, the keys can have embedded microchips that store a different electronic signature, or can simply have a different shape. This can advantageously permit a parent to enable PED use whenever the parent is driving but disable such use whenever their child is driving by simply giving the child a “PED-use-disabled” key and keeping a “PED-use-enabled” key for themselves.

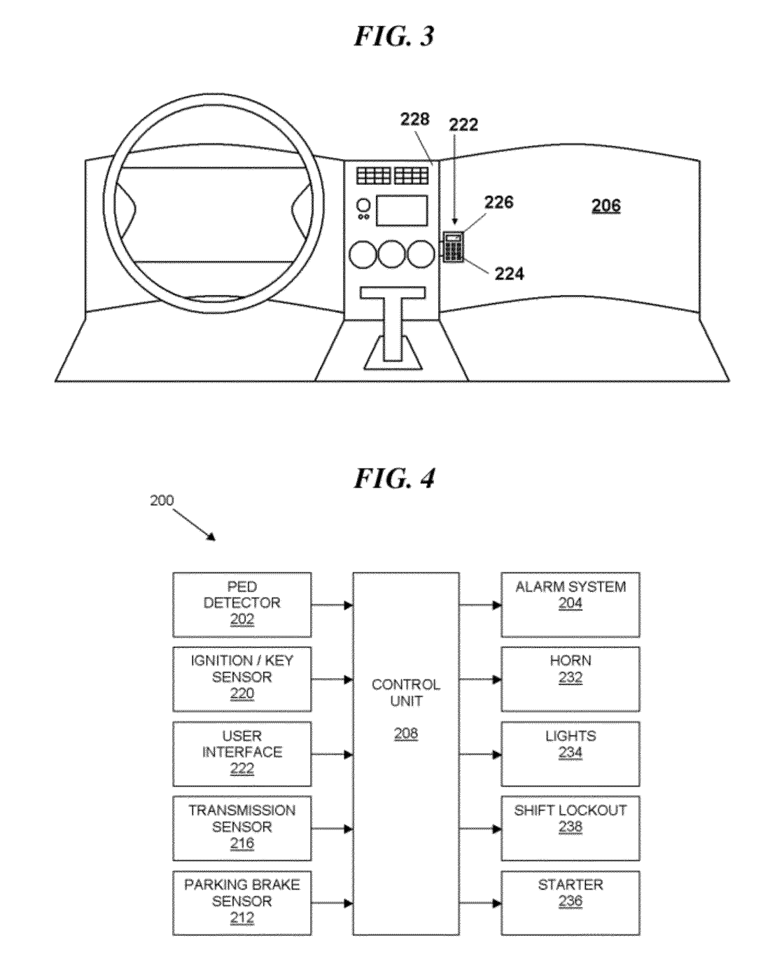

As shown in FIG. 3, the system 200 can also include a user interface 222 which can be disposed inside the vehicle 206. The user interface 222 can be integrated with various existing interface systems of the vehicle 206 (e.g., navigation systems, radio preset buttons, a computer system mounted in the vehicle's center stack, etc.) or can be in the form of a standalone device having various buttons, displays, touch screens, etc. The user interface 222 can also be provided as an application or program that is executed on a PED. The illustrated user interface 222 includes a key pad 224 and a display 226 that is mounted to the dashboard 228 of the vehicle 206. An operator can use the key pad 224 to enter an override code or password to selectively disable the system 200 to permit PED use in the vehicle 206. Alternatively, or in addition, the user interface 222 can include a fingerprint reader. The fingerprint reader can scan an operator's fingerprint and, by comparing the scanned fingerprint to one or more stored fingerprint images, determine whether or not the operator is approved for PED use.

Referring again to FIG. 2, the control unit 208 can also interface with a variety of other sensors and systems installed in the vehicle 206. An alarm system 204, the vehicle horn 232, and the vehicle's lights 234 can all be electronically controlled by the control unit 208 to selectively provide a visible or audible alert when PED use and/or presence is detected. For example, the control unit 208 can selectively trigger the alarm system 204, sound the horn 232, or flash the vehicle's lights 234. It will be appreciated that any lights in or on the vehicle can be flashed, including headlights, taillights, reverse lights, brake lights, side marker lights, turn signals, dome lights, etc.

The system 200 can also include features for safely preventing operation of the vehicle 206 when PED use and/or presence is detected. For example, when the vehicle's engine is not running, the control unit 208 can disable the vehicle's starter 236 when PED use is detected to prevent an operator from starting the engine until the PED is turned off or until it is placed in standby mode. Similarly, when the vehicle's transmission 218 is in park, the control unit 208 can activate a shift lockout 238 when PED use and/or presence is detected to prevent an operator from shifting the vehicle out of park until the PED is no longer in use or until it is powered off.

FIG. 4 illustrates a schematic block diagram of the input/output relationships of the control unit 208 and various other components of the system 200 or the vehicle 206. As shown, the control unit 208 can receive inputs from the PED detector 202, the ignition/key sensor 220, the user interface 222, the transmission sensor 216, and/or the parking brake sensor 212. The control unit 208 can also provide outputs to one or more of the alarm system 204, the horn 232, the lights 234, the shift lockout 238, and the starter 236.

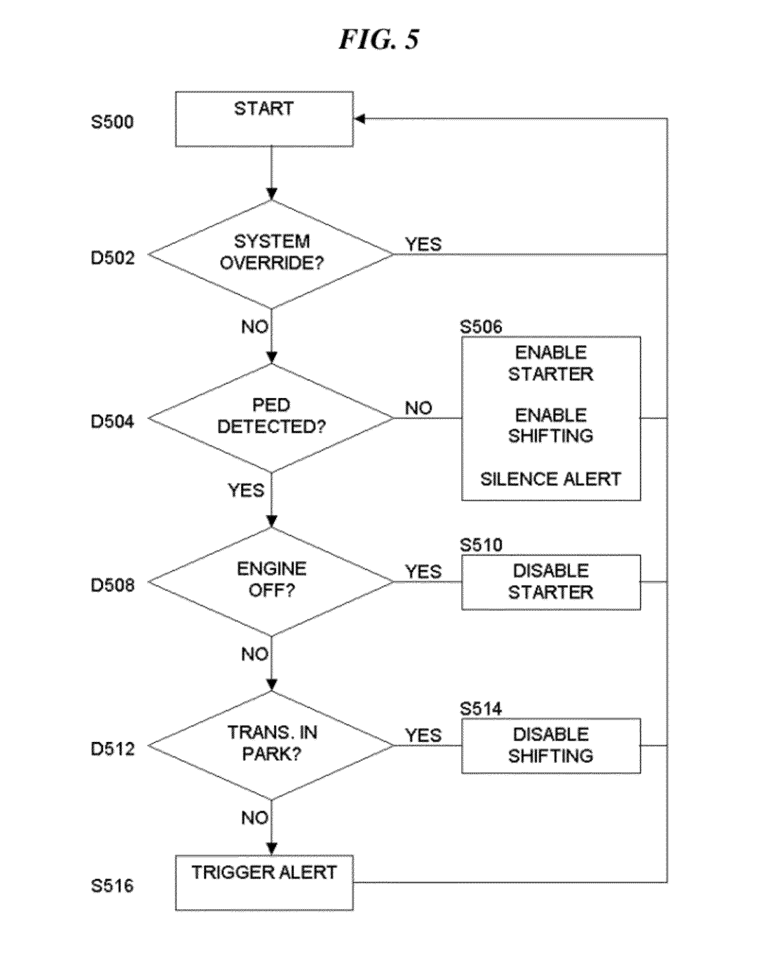

FIG. 5 is a flow chart of one exemplary mode of operation of the vehicle safety system 200. Execution begins at step S500 when the system 200 is powered on (e.g., when a key is inserted into the ignition of a vehicle in which the system 200 is installed). The system 200 then determines whether an override condition is present at decision block D502. If an override exists (e.g., an appropriate password has been entered, or a “parent” key is detected), execution returns to step S500. This process repeats until the override condition is no longer present, at which time execution proceeds to decision block D504, where the presence or absence of a PED is determined. If no PEDs are detected and, optionally, if all detected PEDs are in standby mode, the system 200 enables or continues to enable the engine starter and shifting of the vehicle's transmission at step S506. The system 200 also clears or silences any alert condition that may exist and returns to step S500.

If a PED (e.g., a cell phone in standby mode or in active use) is detected at decision block D504, execution proceeds to decision block D508 to determine if the vehicle's engine is running. If the engine is not running, the starter is disabled at step S510 and execution returns to step S500 without triggering an alert. The operator can thus continue to use the PED without triggering an alert, but will be unable to start the engine until they discontinue use of the PED.

If the engine is running, execution proceeds to decision block D512 to determine if the vehicle's transmission is set to a non-moving gear (e.g., the transmission is in park). If the transmission is in park, shifting of the transmission is disabled at step S514 and execution returns to step S500 without triggering an alert. The operator can thus continue to use the PED without triggering an alert, but will be unable to shift the transmission into drive or reverse until they discontinue use of the PED.

If the transmission is in a moving gear (e.g., not in park), an alert is triggered at step S516. For example, the vehicle's alarm or horn can be sounded and the vehicle's lights can be flashed. Execution then returns to step S500 and the process repeats.

It will thus be appreciated that the system 200 is capable of deterring PED use and/or presence while driving without requiring sudden and dangerous vehicle immobilization (i.e., by instead triggering a visible or audible alert when PED use and/or presence is detected in a moving vehicle or a vehicle in which the engine is running). Various immobilization features can be employed when it is safe to do so, however, such as when the engine is not running or when the vehicle's transmission is in park.

Any of the systems disclosed herein can also include a delay system and/or an initial warning system. For example, when PED use and/or presence is detected, a vehicle safety system can be configured to wait for a predetermined delay period (e.g., 5, 10, 30, or 60 seconds) to elapse before triggering an alarm condition. The delay period can optionally be operator-configurable. Such delay systems can allow time for an operator to disable or turn off the detected PED, or to assert an override condition (e.g., by entering a valid override password) before the alarm is triggered. The delay system can optionally be active only when an operator first enters a vehicle or first starts the vehicle's engine, such that the delay is not present for subsequent PED detections.

In one embodiment, the system can include an initial warning system that is configured to emit a verbal warning, a low-volume audible warning, a visual warning, or any other type of warning when the delay period begins to run. This warning can alert an operator that PED use has been detected and that an alarm condition will be triggered if no action is taken within the delay period.

The systems disclosed herein can also include a master shutoff feature that allows the system to be disabled indefinitely (e.g., until actively re-enabled by an operator). This can allow an operator to perform a one-time deactivation, without having to re-enter a password or other override every time they use the vehicle.

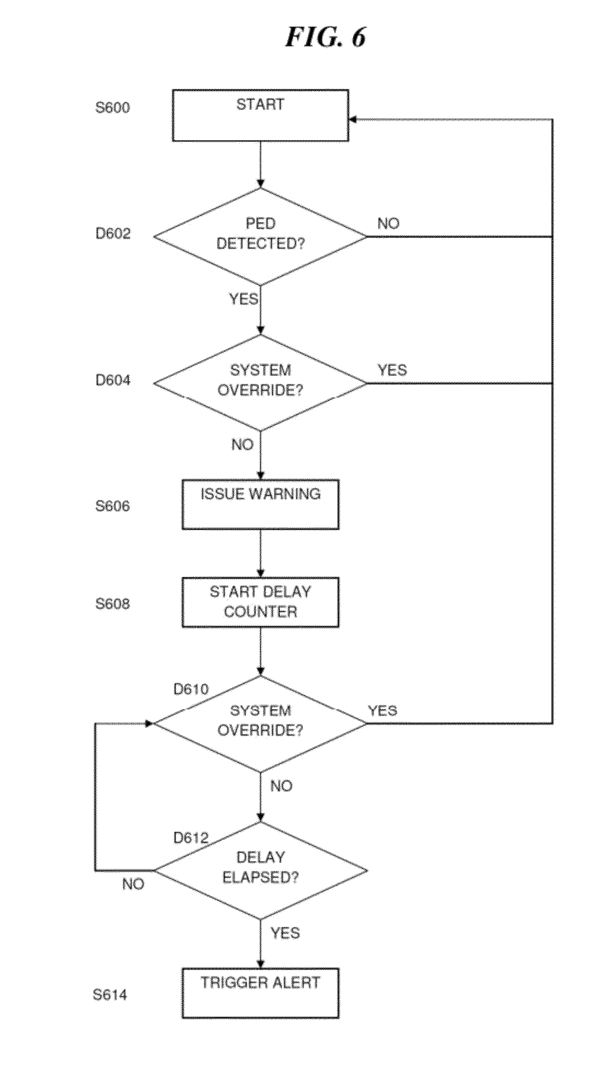

FIG. 6 is a flow chart of one exemplary mode of operation of a vehicle safety system having a delay/initial warning system. Execution begins at step S600 when the system is powered on (e.g., when a key is inserted into the ignition of a vehicle in which the system is installed). The system then determines whether a PED is detected at decision block D602. If no PED is detected, execution returns to step S600, and the process repeats until a PED is detected. If a PED is detected at decision block D602, the system determines whether an override condition is present at decision block D604. If an override exists (e.g., an appropriate password has been entered, or a “parent” key is detected), execution returns to step S600 and the process repeats. If no override condition exists, execution proceeds to step S606 in which a warning is issued to vehicle occupants. The warning can be visible (e.g., a flashing light) and/or audible (e.g., a low-volume beep or a recorded or computer generated voice prompting an operator to enter a password). Execution then proceeds to step S608, where a delay counter begins counting a predetermined delay period.

The system then checks for an override condition again at decision block D610. If an override condition is present, execution returns to step S600, without triggering an alert. On the other hand, if no override condition is present, the system checks to see if the delay time period has elapsed in decision block D612. If the delay time period has not yet elapsed, execution returns to decision block D610. If the delay time period has elapsed, execution proceeds to step S614, in which an alert is triggered. Thus, in the illustrated operating mode, the system issues a warning to the user when PED use is detected and no override condition exists. The system also starts a delay timer and continually checks for an override condition until either the timer elapses (in which case an alarm is triggered) or an override condition is detected (in which case the alarm is not triggered and the process repeats).

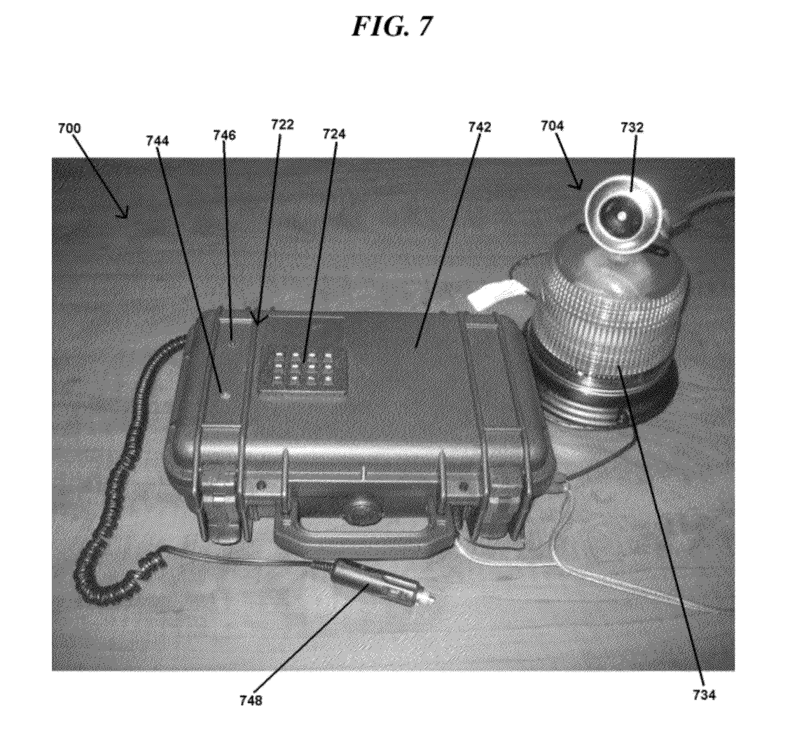

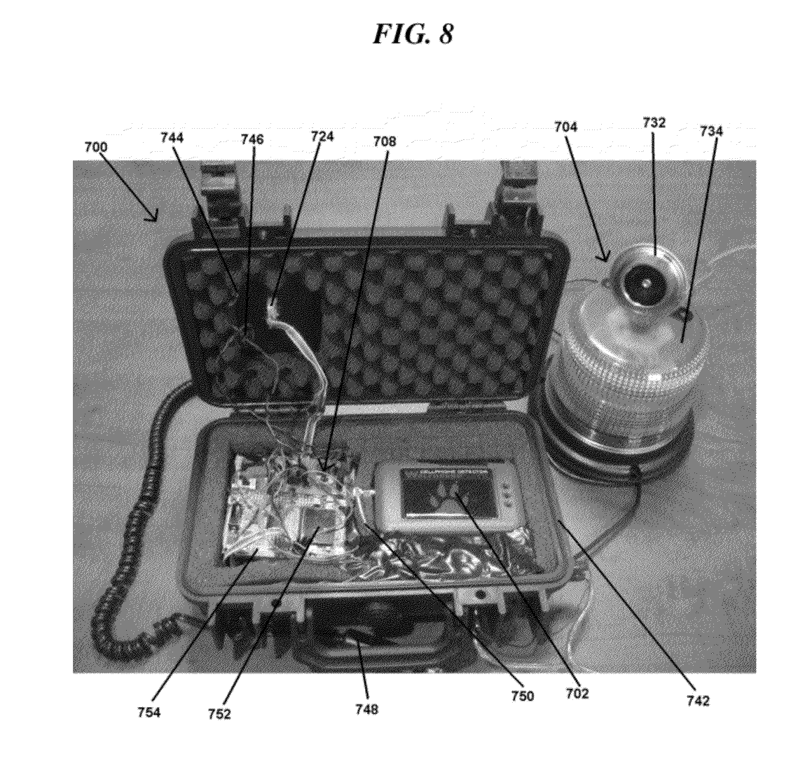

FIGS. 7-8 illustrate another exemplary embodiment of a vehicle safety system 700. The system 700 includes a housing 742 in which a PED detector 702 and a control unit 708 are disposed and to which a user interface 722 is mounted. The user interface includes a keypad 724, a “power-on” LED 744, and a “PED activity” LED 746. The system 700 also includes a power adapter 748 for coupling the system 700 to a vehicle's accessory power bus. The system 700 is coupled to an alarm system 704 which includes a horn 732 and a light 734.

In the illustrated embodiment, the PED detector 702 is a Wolfhound-Lite cell phone detector, which is commercially-available from Berkeley Varitronics Systems of Metuchen, N.J. The PED detector 702 can optionally be coupled to an auxiliary antenna unit (not shown) via an antenna cable 750. The auxiliary antenna unit can be coupled to the exterior of the housing 742.

The illustrated control unit 708 includes a Stellaris LM3S2965 microcontroller 752, which is commercially available from Texas Instruments of Dallas, Tex., mounted to a printed circuit board 754 with associated memory, logic, and power conditioning components. The control unit 708 also includes a first input to which an optical sensor (not shown) is coupled. The optical sensor detects illumination of an LED on the PED detector 702, which indicates that PED activity has been detected. The control unit 708 also includes a second input to which the user interface 722 is coupled, such that a password entered into the keypad 724 can be communicated to the control unit 708. The control unit 708 also includes a first output to which the alarm system 704 is coupled and a second output to which the user interface 722 is coupled.

In use, power is supplied from the vehicle's accessory power bus to the system via the power adapter 748. The “power-on” LED 744 is illuminated on the exterior of the system's housing 742 to indicate that the system 700 is receiving power. When PED activity is detected by the PED detector 702, the detector illuminates its LED to indicate that activity has been detected. The illumination of the LED is detected by the optical sensor and communicated to the control unit 708 via the first input. The control unit 708 can include an analog-to-digital converter as known in the art to convert analog sensor output to a digital signal. When PED activity is detected, the control unit illuminates the PED-activity LED 746, thereby warning a user that an alarm condition will be triggered unless an override condition is asserted within a predetermined delay period. The user can then enter a password using the keypad 724 of the user interface 722. When a password is entered, the control unit 708 can compare the entered password to a password stored in the control unit's memory to determine whether a valid password has been entered. If a valid password is not entered before the delay period elapses, the control unit 708 triggers an alarm condition and drives the first output to sound the horn 732 and cause the light 734 to flash.

The devices and methods disclosed herein can be employed in a variety of vehicles, including without limitation cars, trucks, buses, trains, trolleys, boats, planes, forklifts, construction equipment, heavy machinery, etc. These devices and methods also have application in mass transit settings. For example, the systems disclosed herein can be used to detect PED use by a subway train operator and to generate a responsive alert, such as broadcasting a message to the passenger compartment of the train that the driver might be distracted. Such messages would typically deter the use of PEDs by the train operator.

Although the invention has been described by reference to specific embodiments, it should be understood that numerous changes may be made within the spirit and scope of the inventive concepts described. Accordingly, it is intended that the invention not be limited to the described embodiments, but that it have the full scope defined by the language of the following claims.

What is claimed is:

1. A vehicle safety device comprising:
a detector configured to detect portable electronic device activity within a vehicle;
a control unit configured to trigger an alert when the detector detects portable electronic device activity within the vehicle; and
an override mechanism configured to selectively prevent the alert from being triggered when the detector detects portable electronic device activity within the vehicle.

2. The device of claim 1, wherein portable electronic device activity comprises transmissions made by a cellular phone while in standby mode.

3. The device of claim 1, wherein the control unit activates an alarm system to trigger the alert.

4. The device of claim 1, wherein the alert is selected from the group consisting of sounding a horn, flashing a light, and playing an audible message.

5. The device of claim 1, wherein the override mechanism comprises a user interface through which an operator can enter authentication information.

6. The device of claim 5, wherein the user interface comprises at least one of a touch screen, an application executable on a portable electronic device, and a fingerprint reader.

7. The device of claim 5, wherein the authentication information comprises at least one of a password and a fingerprint signature of an operator.

8. The device of claim 1, wherein the override mechanism comprises a sensor for detecting a type of a key used to access or start the vehicle.

9. The device of claim 1, wherein the detector includes a direction-finding antenna and is configured to distinguish between a portable electronic device in use by an operator of the vehicle and a portable electronic device in use by a passenger of the vehicle.

10. The device of claim 1, wherein the control unit disables a starter of the vehicle if an engine of the vehicle is stopped and the detector detects that portable electronic device activity within the vehicle.

11. The device of claim 1, wherein the control unit disables shifting of a transmission of the vehicle if the transmission is set to a non-moving gear and the detector detects portable electronic device activity within the vehicle.

12. A method of deterring use of portable electronic devices within a vehicle, comprising:
detecting portable electronic device activity within the vehicle; and
triggering an alert if portable electronic device activity is detected;
wherein the alert is only triggered if portable electronic device activity is detected and no override condition exists.

13. The method of claim 12, wherein portable electronic device activity comprises transmissions made by a cellular phone while in standby mode.

14. The method of claim 12, further comprising setting the override condition when an operator enters a valid password, uses a valid key to access or start the vehicle, or enters a valid fingerprint signature.

15. The method of claim 12, further comprising setting the override condition from an application executed on a portable electronic device.

16. The method of claim 12, wherein triggering an alert comprises at least one of activating an alarm system, sounding a horn, and flashing one or more lights.

17. The method of claim 12, wherein triggering an alert comprises broadcasting an audible message to a passenger cabin of the vehicle.

18. The method of claim 12, further comprising distinguishing between a portable electronic device in use by an operator of the vehicle and a portable electronic device in use by a passenger of the vehicle and wherein the alert is only triggered if operator use is detected.

19. The method of claim 12, further comprising disabling a starter of the vehicle if an engine of the vehicle is off and portable electronic device activity is detected.

20. The method of claim 12, further comprising disabling shifting of a transmission of the vehicle if the transmission is set to a non-moving gear and portable electronic device activity is detected.
